(19) United States
(12) Patent Application Publication
(10) Pub. No.: US 2015/0134867 A1
(43) Pub. Date: May 14, 2015

(54) DEVICE AND METHOD FOR INTERRUPT COALESCING

(71) Applicant: SIEMENS AKTIENGESELLSCHAFT, München (DE)

(72) Inventor: Christian HILDNER, Nuremberg (DE)

(73) Assignee: SIEMENS AKTIENGESELLSCHAFT, München (DE)

(21) Appl. No.: 14/597,912

(22) Filed: Jan. 15, 2015

Related U.S. Application Data
(63) Continuation of application No. PCT/EP2012/064004, filed on Jul. 17, 2012.

(51) Int. Cl. G06F 13/24

(52) U.S. Cl. CPC G06F 13/24; G06F 2213/2406
USPC 710/267

(57) ABSTRACT

An external logic device for a network interface controller enables interrupt coalescing from a network interface controller. The network interface controller has a cause register for storing information about interrupt causes and drives an interrupt line. The external logic device is connectable to the cause register for reading the contents of the cause register, and to the interrupt line of the network interface controller and to an interrupt input of a processor for forwarding interrupts from the interrupt line of the network interface controller to the processor. The external logic device has a timer which is initializable when the interrupt line contains an interrupt, and is constructed to delay the forwarding of interrupts, depending on the current contents of the cause register, until a timeout of the timer is reached.

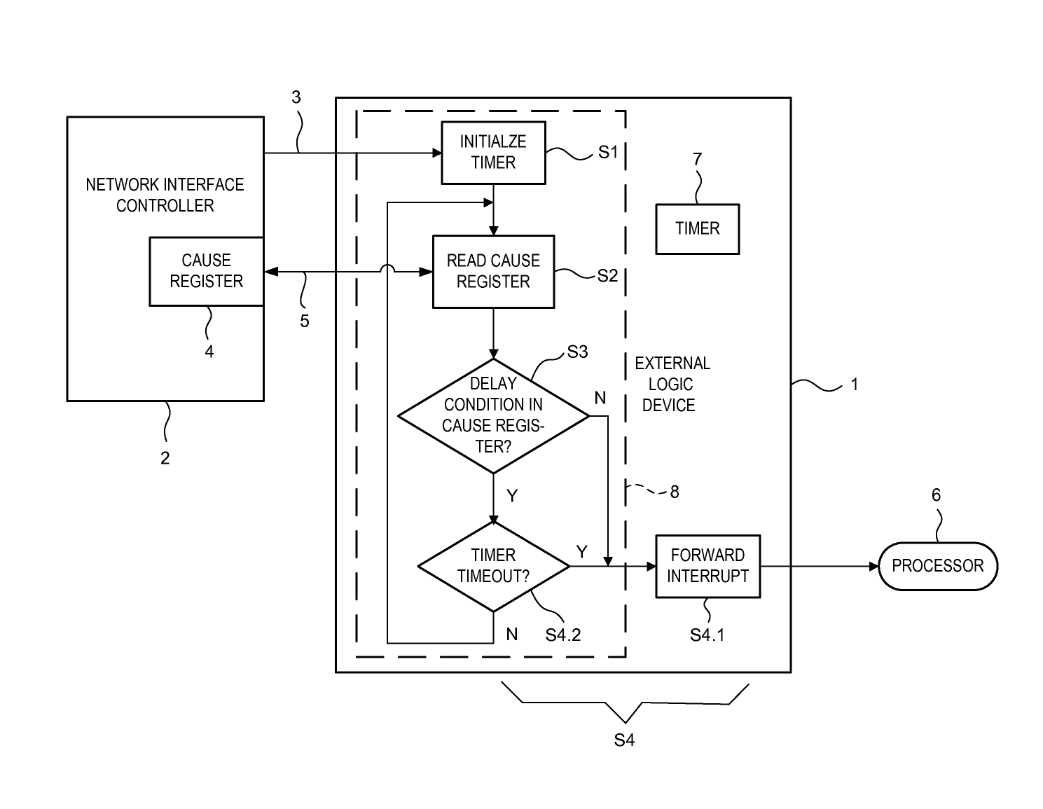

### CROSS REFERENCE TO RELATED APPLICATIONS

This application is a continuation application of International Application No. PCT/EP2012/064004, filed Jul. 17, 2012 and designating the U.S., the entire contents of which are incorporated herein by reference.

### BACKGROUND

Described below are an external logic device for a network interface controller to enable interrupt coalescing and a method to forward interrupts from an interrupt line to a processor by such an external logic device.

Interrupt coalescing is a well known method to minimize the overhead of multiple interrupts that would occur on a standard network interface controller when multiple network packets will arrive. Packets are collected until the number of collected packets exceeds a threshold or a timeout occurs. When the number of collected packets exceeds the threshold or the timeout occurs, an interrupt is generated and a host processor will execute the basic interrupt handling only once, serving more than one packet to the application program(s).

US 2011/093637 A1 discloses a technique for interrupt moderation allowing coalescing interrupts from a device into groups to be processed as a batch by a host processor. Receive and send completions may be processed differently.

US 2009/177829 A1 discloses an interrupt redirection and coalescing system for a multi-processor computer. Devices interrupt a processor or group of processors using pre-defined message address and data payloads communicated with a memory write transaction.

US 2008/147946 A1 discloses an event priority based interrupt coalescing mechanism for generating interrupt requests in environments with different interrupt sources by an interrupt controller.

US 2008/235424 A1 discloses an interrupt coalescing mechanism by a controller that interrupts a CPU based on a counter that uses a decrement step which may increase as high priority data packets are received by the controller.

US 2008/147905 A1 discloses interrupt coalescing by an interrupt coalescing unit coupling a DMA controller to a CPU for aggregation of data transfer interrupts generated by the DMA controller.

US 2011/179413 A1 discloses methods and systems for virtualization of interrupt coalescing.

US 2010/274940 A1 discloses interrupt coalescing which includes dynamically basing a current level of interrupt coalescing upon a determination of outstanding input/output commands for which corresponding input/output completions have not been received.

### SUMMARY

Described below is a device for a network interface controller to enable interrupt coalescing when the network interface controller itself does not support interrupt coalescing.

Also described below is a method to enable interrupt coalescing with a network interface controller which by itself does not support interrupt coalescing.

Described below is an external logic device for a network interface controller that enables interrupt coalescing, where the network interface controller has a cause register for storing information about interrupt causes and driving an interrupt line. The external logic device is connectable to the cause register for reading the contents of the cause register. Furthermore it is connectable to the interrupt line of the network interface controller and to an interrupt input of a processor for forwarding interrupts from the interrupt line of the network interface controller to the processor. In addition the external logic device has a timer which is initializable when the interrupt line contains an interrupt, and is constructed to delay the forwarding of interrupts, depending on the current contents of the cause register, until a timeout of the timer is reached.

The external logic device provides a way of supplementing the network interface controller to delay the forwarding of interrupts. This advantageously enables interrupt coalescing with a network interface controller which by itself does not support interrupt coalescing. The timer of the external logic device thereby allows to define a timeout to limit the delay of interrupts. In particular, the timer therefore can be used to prevent that interrupts collected by the network interface controller are never forwarded to the processor.

In an embodiment the external logic device includes a field-programmable gate array configurable to delay the forwarding of interrupts, depending on the current contents of the cause register, until a timeout of the timer is reached.

The use of a field-programmable gate array is advantageous because it makes the external logic device programmable and thus adaptable to the network interface controller and to the requirements of a particular interrupt coalescing.

Furthermore the external logic device may have an interface to a PCI bus for connecting the external logic device to the network interface controller.

This makes the external logic device advantageously connectable to a network interface controller via a PCI bus and thus adapts the external logic device to standard hardware environments.

A method for interrupt coalescing controls forwarding interrupts from an interrupt line to a processor by an external logic device, when the interrupt line is driven by a network interface controller having a cause register for storing information about interrupt causes. The method includes:
defining at least one delay condition corresponding to an information storable in the cause register of the network interface controller,
defining a timeout for the timer of the external logic device,
and configuring the external logic device to conduct the following:
initializing the timer of the external logic device,
reading the contents of the cause register,
checking whether the delay condition is stored in the cause register, and
returning to reading the contents, if both the delay condition is stored in the register and the timeout of the timer is not yet reached, or, elsewise, forwarding the interrupt to the processor.

Hence, according to the method the forwarding of interrupts to the processor is delayed in cases defined by a delay condition, with the delay limited by a timeout. The delay condition allows one to distinguish types of interrupts which may be delayed before being processed from types of interrupts which are not to be delayed. The timeout prevents that interrupts are delayed for too long.

As an example of a delay condition, the receipt by the network interface controller of an interrupt request is used below.

This delay condition advantageously allows the external logic device to control the forwarding of incoming interrupt requests and thus to model interrupt coalescing known in the prior art.

### BRIEF DESCRIPTION OF THE DRAWINGS

These and other aspects and advantages will become more fully understood and more readily appreciated from the detailed description given hereinbelow and the accompanying drawing which are given by way of illustration only and thus are not limitive of the present invention.

The FIGURE is a combination block diagram and flowchart illustrating interrupt coalescing by an external logic device for a network interface controller.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

The network interface controller 2 supports collecting of receive (RX) packets using direct memory access (DMA) but does not support interrupt coalescing by itself. The network interface controller 2 supports a common interrupt line 3 for transmitting interrupts for the interrupt causes “RX packet received”, “RX queue full”, “transmit (TX) packet sent” and “TX queue empty”. Furthermore the network interface controller 2 has a cause register 4 for storing the respective interrupt cause for each interrupt. The interrupt cause “RX packet received” indicates a packet received by the network interface controller 2 via the network. The interrupt cause “RX queue full” indicates that the number of such packets collected by the network interface controller 2 has reached the capacity of a corresponding queue for collected RX packets (this capacity might be configurable). The interrupt cause “TX packet sent” indicates that a TX packet is sent by the network interface controller 2. The interrupt cause “TX queue empty” indicates the absence of further TX packets.

The external logic device 1 includes a field-programmable gate array connected via a PCI bus 5 (PCI=peripheral component interconnect) to the network interface controller 2 for reading the contents of the cause register 4. Furthermore the external logic device 1 is connected to the interrupt line 3 and to an interrupt input of a processor 6 for forwarding interrupts from the interrupt line 3 to the processor 6.

In addition the external logic device 1 has a timer 7 which is initializable when the interrupt line 3 contains an interrupt and which provides a predefined timeout.

To accomplish interrupt coalescing, the field-programmable gate array 8 (or equivalent processing means) of the external logic device 1 is configured to conduct the following when an RX packet is received:

In S1, the timer 7 is initialized (started).

In S2, the contents of the cause register 4 is read.

In S3, it is checked whether a predefined delay condition is stored in the cause register 4. The delay condition is in this case that the interrupt cause is “RX packet received”.

If the result of S3 is negative, i.e. if the interrupt cause is not “RX packet received” but any of the other interrupt causes (“RX queue full”, “TX queue empty” or “TX packet sent”), then the interrupt is in a first alternative S4.1 of S4 directly forwarded to the processor 6.

If the result of S3 is positive, i.e. if the interrupt cause is indeed “RX packet received”, then it is checked in a second alternative S4.2 of S4 whether the timeout of the timer 7 is reached. If the result is positive, i.e. if the timeout is reached, then the interrupt is forwarded to the processor 6. Otherwise the process is continued with the reading in S2.

In this manner interrupt coalescing is modelled by the dividing the coalescing method into two parts:
a) An interrupt is scheduled when a predefined number of RX packets has been collected by the network interface controller 2. This function is implemented by an “RX queue full” interrupt which is directly forwarded to the processor 6 by the external logic device 1 in the first alternative S4.1 of S4.
b) An interrupt is also scheduled when the timeout is met even though the RX queue is not yet completely filled. This function is implemented by the timer 7 that is started on occurrence of a common interrupt and checked in a loop. Within the loop the external logic device 1 reads the cause register 4 to allow all interrupts except for “RX packet received” interrupts to be forwarded directly to the processor 6.

The effect of the external logic device 1 is, that the processor 6 can handle the interrupts with “RX queue full”, “TX queue empty”, “TX packet sent” directly, while exclusively the “RX packet received” interrupts are (possibly) delayed, thus allowing the network interface controller 2 to collect more RX packets and let the processor 6 process them in a batched manner when the interrupt is finally being forwarded. The benefit is the same as with known interrupt coalescing with the use of collecting RX packets and delivering by chance more than a single packet per interruption.

It should be understood that the detailed description and specific examples, while indicating preferred embodiments, are given by way of illustration only, since various changes and modifications within the spirit and scope of the invention will become apparent to those skilled in the art from this detailed description and the following claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. An external logic device for a network interface controller to enable interrupt coalescing for a processor, the network interface controller having a cause register for storing information about interrupt causes and driving an interrupt line, the external logic device comprising:
a first interface connectable to the cause register to access contents of the cause register;—and
at least a second interface connectable to the interrupt line of the network interface controller and to an interrupt input of the processor for forwarding interrupts from the interrupt line of the network interface controller to the processor;
a timer initializable when the interrupt line contains an interrupt; and
processing means for delaying the forwarding of the interrupts, depending on current contents of the cause register, until a timeout of the timer is reached.

2. The external logic device according to claim 1, wherein said processing means is a field-programmable gate array configurable to delay the forwarding of the interrupts, depending on the current contents of the cause register, until a timeout of the timer is reached.

3. The external logic device according to claim 2, wherein said second interface includes a PCI interface to a PCI bus for connecting the external logic device to the network interface controller.

4. The external logic device according to claim 1, wherein said second interface includes a PCI interface to a PCI bus for connecting the external logic device to the network interface controller.

5. A method to forward interrupts from an interrupt line to a processor by an external logic device, the interrupt line being driven by a network interface controller having a cause register for storing information about interrupt causes, said method comprising:
defining at least one delay condition corresponding to an information storable in the cause register of the network interface controller;
defining a timeout for the timer of the external logic device; and
configuring the external logic device to perform:
initializing the timer of the external logic device,
reading contents of the cause register,
checking whether the at least one delay condition is stored in the cause register, and
returning to reading contents of the cause register when both the at least one delay condition is stored in the cause register and the timeout of the timer is not yet reached, and otherwise forwarding the interrupt to the processor.

6. A method according to claim 4, wherein receipt by the network interface controller of an interrupt request is used as the at least one delay condition.
